(19) United States
(12) Patent Application Publication
(10) Pub. No.: US 2005/0241320 A1
(43) Pub. Date: Nov. 3, 2005

(54) System for cooling cooling air in a gas turbine, and method for cooling cooling air

(76) Inventors: Jann Blonn, ERLANGEN (DE); Alfred Kessler, Heroldsberg (DE); Oliver Konig, Erlangen (DE); Helmut Stierstorfer, Erlangen (DE)

Correspondence Address: Siemens Corporation;Intellectual Property Department, 170 Wood Avenue South, Iselin, NJ, 08830, US

(21) Appl. No.: 10/521,904

(22) PCT Filed: Jul. 14, 2003
(86) PCT No.: PCT/DE03/02363

§ 371 Date: Jan. 20, 2005

(30) Foreign Application Priority Data
Jul. 25, 2002 (DE) 102 33 948.1

(51) Int. Cl. F02C 7/12

(52) U.S. Cl. 60/782; 60/806

(57) ABSTRACT

Disclosed is a gas and steam turbine plant comprising a cooling system which is configured such that said cooling system is suitable for each operational state and cools cooling air that is bled from the compressed air, and a heat exchanger system which is mounted on the primary side of a cooling air duct that branches off the compressed air duct. Said heat exchanger system transmits heat that is transported in the cooling air to a flow of combustible gas which is fed to the combustion chamber of the gas turbine.

The invention relates to a cooling system for cooling down the cooling air which is tapped off from the compressor air in a gas turbine. It also relates to a method for cooling the cooling air.

In a gas and steam-turbine system, the heat which is contained in the expanded working medium (exhaust gas) from the gas turbine is used to generate steam for the steam turbine. The heat is transferred in a waste heat

steam generator which is connected downstream from the gas turbine on the exhaust gas side and in which heating surfaces in the form of tubes or tube groups are arranged. These are in turn connected to the water/steam circuit of the steam turbine.

The steam which is generated in the waste heat steam generator is supplied to the steam turbine, where it is expanded producing work. The steam which is expanded in the steam turbine is normally supplied to a condenser, where it is condensed. The condensate which is produced from the condensation of the steam is supplied once again as supply water to the waste heat steam generator, thus resulting in a closed water/steam circuit.

In order to increase the power of the gas turbine and thus to achieve a gas and steam-turbine system such as this whose efficiency is as high as possible, it is desirable for the exhaust gas or the combustion gases to be at a particularly high temperature of, for example, 1000° C. to 1200° C. when they enter the gas turbine. However, a turbine inlet temperature that is as high as this results in material problems, particularly with regard to the heat resistance of the turbine blades.

The turbine inlet temperature cannot be increased unless the turbine blades are cooled sufficiently that they are always at a temperature that is below the maximum permissible material temperature. In this context, it is known from EP-PS 0 379 880 for a flow element to be tapped off from compressed air as it flows out of the compressor associated with the gas turbine, and for this flow element to be supplied as a cooling medium to the gas turbine. The air which is used as a cooling medium is cooled before it enters the gas turbine. In this case, an auxiliary steam generator, which is also referred to as a kettle boiler, absorbs heat which has been extracted from the compressor air and is used, for example, to vaporize water, is normally used when the system is in the gas and steam mode. The steam which is produced during this process is fed into the steam circuit.

However, this auxiliary steam generator is not available when the steam circuit of the system is not in operation. When the system is being used in the pure gas turbine mode, a comparatively large air cooler, which is also referred to as a fin fan cooler, is therefore normally used as an alternative to cool down the cooling air.

Switching from the pure gas-turbine mode to the gas and steam-turbine mode therefore also requires switching between the cooling systems for the cooling air in each case. The cooling down process, which is not ensured continuously owing to the switching process, means that it may not be possible to avoid a load reduction, or even disconnection of the load from the system, when changing from the pure gas-turbine mode to the gas and steam mode.

The invention is thus based on the object of specifying a gas and steam-turbine system cooling system which is suitable for extraction of heat from the cooling air and which can be set flexibly to the operating state of the gas and steam turbine with little hardware complexity. A further aim is to specify a method for cooling the cooling air which is suitable for different system operating conditions.

With regard to the cooling system, this object is achieved according to the invention in that a heat exchanger system, which is connected on the primary side is connected in a cooling air line that is tapped off from the compressor air line, transfers heat that is carried in the cooling air to the combustion gas flow which is supplied to the combustion chamber of the gas turbine.

The invention is in this case based on the idea that reliable cooling down of the cooling air should be ensured irrespective of any heat introduced into the water/steam circuit in the steam turbine in a cooling system which can be flexibly matched to the operating state of the gas and steam turbine system. For this purpose, the cooling system should transfer heat extracted from the cooling air while it is being cooled down to a medium which is available in every operating state of the system. One medium which is particularly suitable for this purpose, whose heating allows heat to be introduced into the actual power generation process, and thus also allows a particular improvement in efficiency, is the combustion gas flow which is supplied to the combustion chamber.

Advantageous refinements of the invention are the subject matter of the dependent claims.

The amount of heat which has been extracted from the cooling air flow for reliably cooling down the cooling air is generally greater than that required to preheat the combustion gas, that is to say based on the normal dimensions of gas and steam-turbine systems. The amount of heat supplied to the combustion gas flow is thus advantageously variable. This ensures that an adequate amount of heat is always available for preheating the combustion gas, and that the remaining amount of heat is dissipated in some other way.

In one preferred refinement, a heat dissipation capability from the cooling air which can be flexibly matched to the operating state of the system is achieved by splitting the heat flow dissipated from the cooling air into flow elements, one of which is supplied to the combustion gas flow and another of which is used, for example, to generate steam which can be supplied to the steam turbine. The split into flow elements is in this case carried out taking account of the condition that the flow element which is supplied to the combustion gas flow carries with it precisely that amount of heat which is required for preheating of the combustion gas, while the further flow element or flow elements dissipate the heat which is not required to preheat the combustion gas or use it in some other way, for example for generation of auxiliary steam. The heat flow can be split by connecting a number of intermediate circuits in parallel on the heat flow side. This results in heat dissipation capabilities in each intermediate circuit, so that the cooling system can be used particularly flexibly.

In a further alternative embodiment, whose hardware is particularly simple, the heat exchanger system may have a heat exchanger whose secondary side is connected directly in the combustion gas flow, and which transfers heat from the cooling air flow to the combustion gas flow.

If already existing components of the gas and steam-turbine system, such as heat exchanger or auxiliary steam generator, are used, as may be desirable by way of example in the case of retrofitting or upgrading measures, then the heat is expediently transferred via at least one intermediate circuit, via which the secondary side of an auxiliary steam generator, which is also referred to as a kettle boiler, is connected to a heat exchanger, with the secondary side of the latter being connected in the combustion gas flow. The configuration of the cooling system can thus be matched to the characteristics of the already existing system, thus saving technical complexity.

If necessary, a further auxiliary steam generator can also be connected in the intermediate circuit and uses the heat to be dissipated to generate auxiliary steam which is required in the system.

In one alternative refinement, the heat-side connection of the heat exchanger system to the further heat exchanger can be provided via the auxiliary steam generator, with the intermediate circuit thus being in two stages. This provides further heat extraction and usage options, and makes the cooling system particularly flexible. Apart from this, a two-stage intermediate circuit allows more design and adaptation options and matching options for the cooling system to existing characteristics and components.

With regard to the method, the object is achieved by heat which has been extracted from the cooling air flow being transferred to the combustion gas flow which is supplied to the combustion chamber of the gas turbine.

In order to ensure optimum use of the heat contained in the cooling air, the amount of heat which is supplied to the combustion gas flow is advantageously matched to the operating state of the gas turbine system.

For this purpose, the cooling air flow which is tapped off from the compressor air is advantageously split into a number of flow elements, one of which supplies the combustion gas flow with the amount of heat required to preheat the combustion gas.

In one particularly simple refinement option, the amount of heat which is provided for preheating the combustion gas is expediently transferred via a heat exchanger whose secondary side is connected directly in the combustion gas flow.

As an alternative to this, a single-stage or even a two-stage intermediate circuit may also be provided. This is particularly expedient when components which already exist in the cooling system, such as heat exchangers or auxiliary steam generators, are intended to be used. In this situation, an intermediate circuit allows the heat flow to be split more flexibly into flow elements, and allows already existing components to be connected more flexibly.

In order to allow optimum use of the heat which is dissipated from the cooling air, an auxiliary steam generator is expediently connected in one of the flow elements which are not supplied to the combustion gas flow. This auxiliary steam generator uses the excess amount of heat as vaporization heat for generation of auxiliary steam that is required in the system, and thus contributes to increasing the efficiency of the system.

The advantages achieved by the invention are, in particular, that transferring at least a portion of the heat extracted from the cooling gas flow to the combustion gas flow increases the efficiency of the gas and steam-turbine system in the pure gas-turbine mode by saving external preheating sources. Since a significant proportion of the heat extracted from the cooling air when cooling it down can be reliably dissipated can, furthermore, be reliably dissipated via the combustion gas flow in any case, irrespective of the operating state of the steam turbine, this allows switching from the pure gas-turbine mode to the gas and steam mode without the previously unavoidable load reduction or load disconnection. Furthermore, there is no need for various components which occupy a large amount of space, such as external heating gas preheaters and the comparatively large air cooler, which is also referred to as a fin fan cooler.

One exemplary embodiment of the invention will be explained in more detail with reference to a drawing, in which:

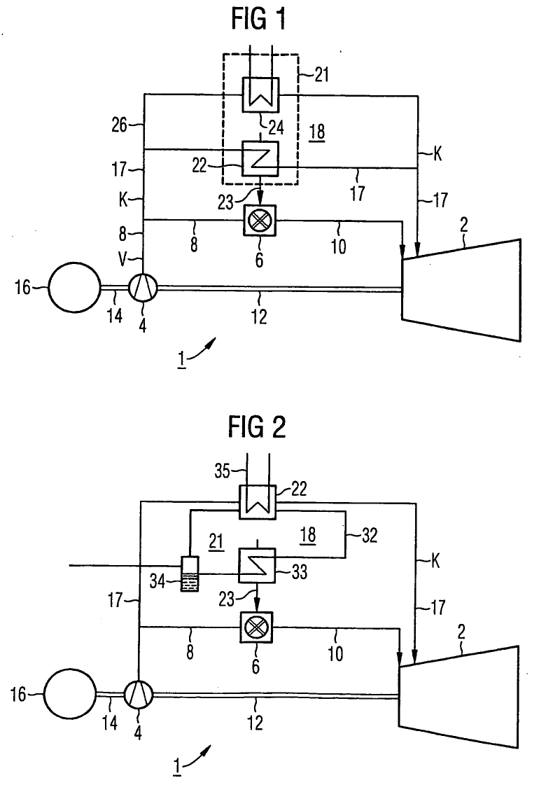

FIG. 1 shows, schematically, a cooling system for cooling the cooling air for a gas turbine,

FIG. 2 shows a cooling system with an intermediate circuit,

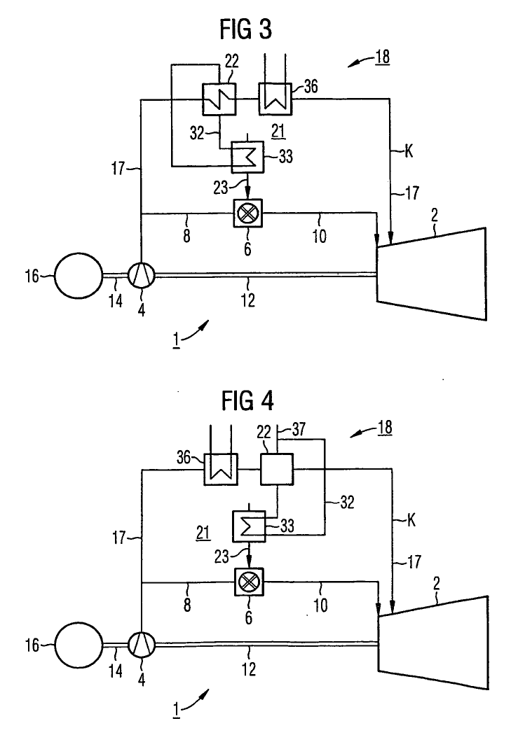

FIG. 3 shows an alternative embodiment of the cooling system with an intermediate circuit,

FIG. 4 shows a further alternative embodiment of the cooling system with an intermediate circuit,

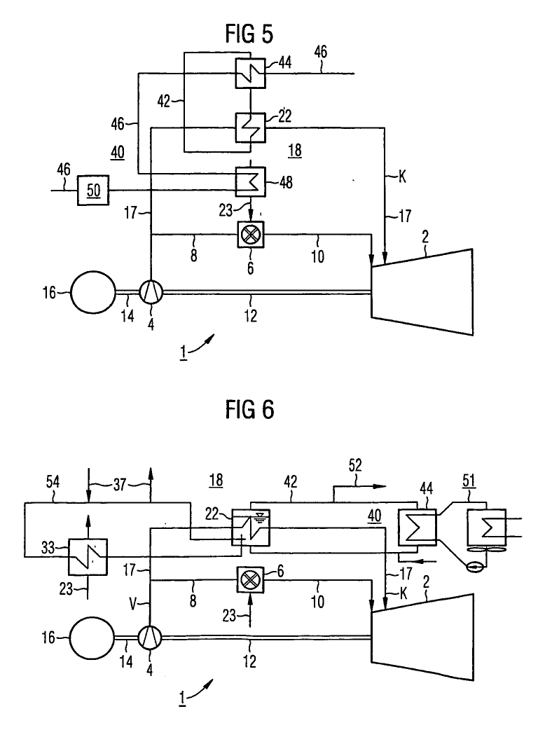

FIG. 5 shows a cooling system with a two-stage intermediate circuit, and

FIG. 6 shows a cooling system with natural circulation and with two intermediate circuits.

Identical parts are provided with the same reference symbols in all of the figures.

The gas turbine system 1 shown in FIG. 1 is part of a gas and steam-turbine system which is not illustrated in any more detail. The gas turbine system 1 has a turbine 2, which is preceded by a compressor 4 and a combustion chamber 6. In addition, further combustion chambers may also be provided. The or each combustion chamber 6 can be supplied via a line 8 and thus via the combustion air path with compressed air V from the compressor 4 as combustion air. On the output side, the combustion chamber 6 is connected via a line 10 or an additional connection to the turbine 2. The turbine 2 can in this case be supplied via the line 10 with hot exhaust gas, which has been produced by combustion of a fuel. The turbine 2 and the compressor 4 are connected to one another via a turbine shaft 12. The turbine 2, the compressor 4, the combustion chamber 6, the lines 8, 10 and the turbine shaft 12 are also referred to in their totality as a gas turbine. The compressor 4 is also connected to a generator 16 via a further shaft 14.

The gas turbine system 1 is designed for as high an efficiency as possible. High efficiency is in this case achieved in particular by a high inlet temperature of the exhaust gas into the turbine 2. A high turbine inlet temperature such as this results, however, in material problems, in particular with respect to the heat resistance of the turbine blades. In order to avoid these problems, the turbine blades are cooled sufficiently to ensure that they are always at a temperature below the permissible material temperature.

The turbine can be supplied as cooling air K with a flow element which is tapped off from the compressor air V in order to cool the stationary stator blades (which are not illustrated in any more detail) and the rotor blades, which are likewise not illustrated in any more detail but which rotate with the turbine shaft 12. For this purpose, the input end of a cooling air line 17 is connected to the line 8 downstream from the compressor 4. On the output side, the cooling air line 17 is connected to the turbine 2, so that the air which is intended as cooling air K can be supplied to the stator blades and to the rotor blades of the turbine 2.

In order to cool down the compressed air V, which is intended to be used as cooling air K, a cooling system 18 which comprises a heat exchanger system 21 connected in the cooling air line 17 and having at least one heat exchanger 22 is used. The heat exchanger 22 may in this case be an auxiliary steam generator, which is also referred to as a kettle boiler, and a cooling medium, in particular water, can be applied to its secondary side. The heat exchanger 22 is in this case designed in particular such that the medium to be cooled, that is to say the hot compressor air or compressed air V, is passed through a large number of tubes, while the cooling medium (water) is being supplied, and is generally vaporized.

The cooling system 18 is designed for particularly high system efficiency, with high flexibility at the same time. To this end, the cooling system 18 is designed to transfer heat carried in the cooling air K to the combustion gas flow 23, so that this heat can be used to preheat the combustion gas. This avoids the need for the external combustion gas preheater and components for cooling the cooling air K. Furthermore, this cooling system 18, which is suitable for all the operating states of the gas and steam-turbine system, means that there is no need for any load reduction or load disconnection while switching from the pure gas-turbine mode to the gas and steam mode.

In the exemplary embodiment shown in FIG. 1, the primary side of the heat exchanger 22 is for this purpose connected directly in the cooling air line 17, and its secondary side is connected directly in a combustion gas line, which is intended to carry the combustion gas flow 23. In this case, the heat is transferred from the cooling air K to the combustion gas flow 23 by only a small number of components. However, with a conventional system design, it would be possible to take account of the fact that the amount of heat which can be extracted from the cooling air K for reliable operation of the turbine 2 is greater than the amount of heat which can be transferred, by virtue of the design, to the combustion gas flow 23. For example, it may be necessary to extract from the cooling air K an amount of heat which corresponds to a heating power of about 7 MW while, in contrast, a maximum amount of heat corresponding to a heating power of about 3 MW can be transferred to the combustion gas flow 23. In order to take account of this aspect, the exemplary embodiment envisages only partial transfer of the heat extracted from the cooling air K to the combustion gas flow 23, with the remaining heat which still has to be dissipated in addition to this being transferred to other media.

In order to ensure such distribution of the heat extracted from the cooling air K as required, the exemplary embodiment shown in FIG. 1 provides for the cooling air flow that is to be cooled down to be split into two flow elements. For this purpose, a further heat exchanger 24 is connected in parallel with the heat exchanger 22 in the heat exchanger system 21. The cooling air flow is thus split into two flow elements, with the first flow element being passed via the cooling air line 17 and via the heat exchanger 22, and the second flow element -being passed via branch line 26, which is tapped off from the cooling air line 17, and via the further heat exchanger 24.

In this order in this case also to ensure that the heat extracted from the cooling air K is dissipated in a form matched to the operating state of the system and that the heat exchanger 22 is supplied with heat, the flow elements in the cooling air line 17 and in the branch line 26 are, furthermore, variable by means of fittings that are not illustrated in any more detail. The further heat exchanger 24 dissipates the heat that is not required to preheat the combustion gas and supplies it for another suitable purpose, for example as vaporization heat.

FIG. 2 shows an alternative embodiment option for the cooling system 18. In this exemplary embodiment, the heat exchanger system 21 is designed to transfer heat indirectly from the cooling air K to the combustion gas flow 23 with the interposition of an intermediate circuit 32. In this case, the cooling air K which is tapped off from the compressor air V is passed through the cooling air line 17 and via the first heat exchanger 22. The secondary side of the heat exchanger 22 is connected in the intermediate circuit 32. A further heat exchanger 33 is connected in the intermediate circuit 32, and transfers heat to the combustion gas flow 23, in order to preheat the combustion gas. A separating bottle 34, which is connected downstream from the further heat exchanger 33 in the intermediate circuit 32, supplies the heat exchanger 22 with the medium which transfers the heat, for example water, again. Furthermore, water or steam can be tapped in from the separation bottle 34 and can be supplied, for example, to an auxiliary steam generator, which is not illustrated in any more detail, or to loads.

In order also to allow the possibly desirable splitting on the heat flow side into a number of flow elements in this exemplary embodiment, the heat exchanger 22 may also be designed to have a number of components and, for example, may have a segment in the form of an auxiliary steam generator or kettle boiler, via which a proportion of the heat is supplied for another purpose. This is represented by the heating coil 5 in FIG. 2.

The embodiment option illustrated in FIG. 2 allows the heat extracted from the cooling air K to be dissipated and distributed in a particularly flexible form via the intermediate circuit 32. Furthermore, the intermediate circuit 32 allows physical decoupling of the major functions, specifically on the one hand the heat dissipation from the cooling air K, and on the other hand the heat transfer to the combustion air flow 23. This decoupling allows the use of components which already exist in the system, such as heat exchangers, auxiliary steam generators or a cooling circuit, in which case all that is necessary is to adapt the line routing. This concept is therefore particularly suitable for upgrading already existing systems.

A further variant of the cooling system 18 is illustrated in FIG. 3. In this variant as well, the heat exchanger system 21 includes the heat exchanger 22, whose primary side is connected in the cooling air line 17 and whose hot side is connected to a further heat exchanger 33 via an intermediate circuit 32. Thus, in this variant as well, heat is transferred to the combustion gas via the intermediate circuit 32 and via the further heat exchanger 33, whose secondary side is connected in the combustion gas flow 30. In contrast to the connections shown in FIG. 2, the secondary side of the heat exchanger 22 is, however, in this case connected only in the intermediate circuit 32. A third heat exchanger 36 is in this case provided in order to split the heat flows as required, whose primary side is connected in series in the cooling air line 17 downstream from the heat exchanger 22 and can thus absorb heat which still remains in the cooling air K. The secondary side of the third heat exchanger 36 is connected to components which are suitably chosen to absorb the remaining heat. This circuit has the particularly advantageous feature that the only task of the third heat exchanger 36 is to dissipate the excess heat which cannot be used in the combustion gas flow 23, as is possibly the case in gas and steam-turbine systems. Generally speaking, there is therefore no need to modify or replace existing components.

FIG. 4 illustrates a further embodiment, which is likewise based on the use of an intermediate circuit 32. In this case, the cooling air K is cooled down via the third heat exchanger 36 even before it enters the heat exchanger 22. The intermediate circuit 32 is in this case designed to use water/steam as the medium for transferring heat to the further heat exchanger 33. In this case, the heat exchanger 22 is for this purpose designed as a steam generator. In this case, the amount of heat transferred in the heat exchanger 22 is varied as required by means of the third heat exchanger 36.

An embodiment is also feasible, as illustrated in FIG. 5, in which the heat is transferred from the cooling air K to the combustion gas flow 23 via a two-stage intermediate circuit system 40. In this intermediate circuit system 40, the heat exchanger 22, whose primary side is connected in the cooling air line 17, transfers heat from the cooling air K to a medium which is carried in a first intermediate circuit 42. The primary side of a further heat exchanger 44 is connected in the intermediate circuit 42, and once again transfers heat to a medium which is carried in a second intermediate circuit 46. Finally, the primary side of the heat exchanger 48 is connected in the second intermediate circuit 46, and transfers heat to the combustion gas flow.

This embodiment has the advantage that the dissipation and use of the heat extracted from the cooling air K can be configured particularly flexibly. In particular, there is a large number of options for the line routing and for the connection of further heat loads as required, so that it is also possible to use existing system components in a versatile form. For example, a portion of the heat which is not required to preheat the combustion gas can be used in an auxiliary steam generator 50, which is connected downstream from the heat exchanger 48 in the second intermediate circuit 46, to generate auxiliary steam which is required in the system. Heat which is not required can be dissipated via an air cooler which is not illustrated in any more detail. Furthermore, like the embodiment based on a single-stage intermediate circuit, this embodiment offers a large number of options for the use and connection of components which already exist in the system.

The water/steam mixture that is carried in the intermediate circuit 32 may in this case be connected to the water/steam circuit for the gas and steam-turbine system at different, suitably chosen points in order to provide a particularly high degree of operational flexibility.

FIG. 6 shows an exemplary embodiment in which the rotor air cooling and the heating gas preheating are largely integrated in already existing power station components. In this case, the cooling air K is supplied via the cooling air line 17 to the heat exchanger 22, which is in the form of a kettle boiler, with the required amount of heat being dissipated by vaporization. The steam which is generated on the secondary side in this case can either be supplied to the heat exchanger 44 (which is in the form of a condenser) in the intermediate circuit system 40, or can be supplied to another load in the power station via the auxiliary steam line 52. The intermediate circuit system 40 may in this case in particular be designed as a natural circulation system, with the secondary side of the heat exchanger 44 itself being connected to a cooling-down system 51. A portion of the medium flow from the heat exchange 22, which carries the amount of heat required for heating gas preheating, is passed via a line 54 and via the heat exchanger 33, whose secondary side is connected in the combustion gas flow 23, and then back again into the heat exchanger 22.

Inclusion of the media side in further existing systems is illustrated by way of example by the feed water line 37. A circuit such as this allows all the methods of operation in the gas-turbine mode or in the gas and steam-turbine mode for heating gas combustion or firing. In this case, the functionality of the rotor air cooling remains unaffected in all operating states, even when using a second fuel (for example heating oil)—that is to say without operation of the heat exchanger for heating gas preheating. The present concept is also particularly suitable for retrofitting and conversion of gas-turbine systems by the addition of heating gas preheating, and thus in order to increase the efficiency. Owing to the wide range of connection options which are feasible on the hot side, this is likewise also particularly advantageous for retrofitting a gas-turbine system, to form a gas and steam-turbine system.

1-15. (canceled)

16. A cooling air cooling system in a power generation station, comprising:
a gas turbine having a compressor component, a combustion component, and a turbine component;
a cooling air line with a primary side;
cooling air extracted through the cooling air line from a volume of compressor air; and
a heat exchanger system connected toward the primary side of the cooling air line and receives a portion of the cooling air, wherein the heat exchanger system transfers heat that is carried in the cooling air to a combustion gas flow which is supplied to the combustion chamber of the gas turbine.

17. The cooling system as claimed in claim 16, wherein the amount of heat supplied to the combustion gas flow is changeable.

18. The cooling system as claimed in claim 16, wherein the heat exchanger system has a secondary side.

19. The cooling system as claimed in claim 16, wherein the heat exchanger system is connected on the secondary side of a number of circuit elements which are connected in parallel on the heat flow side.

20. The cooling system as claimed in claim 16, wherein the heat exchanger system comprises a heat exchanger with a secondary side that is connected directly in the combustion gas flow.

21. The cooling system as claimed in claim 16, wherein the heat exchanger system is connected on the secondary side via an intermediate circuit to a further heat exchanger that is connected on a secondary side in the combustion gas flow.

22. The cooling system as claimed in claim 21, via whose intermediate circuit an auxiliary steam generator can be heated.

23. The cooling system as claimed in claim 22, wherein a connection on a heat side of the heat exchanger system to the further heat exchanger is produced via an auxiliary steam generator.

24. A method for cooling a volume of cooling air for a gas turbine, comprising:
removing a portion of air flow as cooling air flow from a compressor;
extracting heat from the cooling air flow; and
transferring the extracted heat to a combustion gas flow and supplying the flow to a combustion chamber of the gas turbine.

25. The method as claimed in claim 24, wherein the amount of heat supplied to the combustion gas flow is matched to the operating state of the gas turbine system.

26. The method as claimed in claim 24, wherein the heat flow extracted from the cooling air is divided and supplied to a number of flow elements.

27. The method as claimed in claim 24, wherein the heat is transferred via a heat exchanger with a secondary side that is connected directly in the combustion gas flow.

28. The method as claimed in claim 24, wherein heat is transferred from a cooling air line to the combustion gas flow via an intermediate circuit.

29. The method as claimed in claim 28, wherein an amount of heat is transferred to an auxiliary steam generator that is connected in the intermediate circuit. 30. The method as claimed in claim 24, wherein in a first circuit an amount of heat is transferred from the cooling air flow a first heat exchanger to an auxiliary steam generator which is connected in a first circuit and is transferred to the combustion gas flow by a further heat exchanger.
